(19) United States
(12) Patent Application Publication
(10) Pub. No.: US 2026/0048444 A1
(43) Pub. Date: Feb. 19, 2026

(54) Underwater Cutting Device for Shipwreck Salvage

(71) Applicant: Zhejiang International Maritime College, Zhoushan (CN)

(72) Inventors: Zailiang Liu, Zhoushan (CN); Bo Zhang, Zhoushan (CN)

(21) Appl. No.: 18/948,998

(22) Filed: Nov. 15, 2024

(30) Foreign Application Priority Data
Aug. 13, 2024 (CN) 2024111038222

(51) Int. Cl. B23D 57/00; B23D 59/00; B23D 61/18

(52) U.S. Cl. CPC B23D 57/0084; B23D 59/007; B23D 61/185

(57) ABSTRACT

An underwater cutting device for shipwreck salvage, comprising a lower support plate, an upper support plate, columnar support rods, and a reinforcing plate, and a plurality of columnar support rods and a reinforcing plate are provided between the lower support plate and the upper support plate, wherein it further comprises holding components, a moving component, and a rope saw component; two holding components are provided between the lower support plate and the upper support plate, and the two holding components are symmetrically arranged; a top of the upper support plate is provided with a moving component, and the moving component is provided with a rope saw component. When in use, place the pipe on the inner side of the right end of the lower support plate and the upper support plate, then operate the two holding components to hold the pipe.

### TECHNICAL FIELD

The invention relates to the technical field of underwater cutting equipment, and in particular to an underwater cutting device for shipwreck salvage.

### BACKGROUND ART

During the shipwreck salvage process, in order to reduce the inconvenience caused by the large size of the shipwreck, underwater cutting device is needed to cut and decompose the hull of the shipwreck. It is common that the cutting personnel wear diving suits and use underwater cutting strips installed on the welding gun to decompose and cut the shipwreck structure or metal parts through the underwater cutting strips.

In the prior art, the patent document with publication number CN214640725U discloses an underwater engineering cutting device, comprising a cutting body, a bottom of the cutting body is installed with a blade through a driving device, a right side of the surface of the blade is sleeved with a semicircular shell, a top of the cutting body is welded with a connecting frame, a surface of the connecting frame is sleeved with a telescopic rope, and a right side of the telescopic rope is installed with a fixing ring through bolts.

During use, it was found that when it was necessary to cut the pipes on the shipwreck, the device needed to be rotated due to the underwater environment, which reduced the convenience of the underwater cutting operations for the staff.

### SUMMARY OF THE INVENTION

In order to solve the above technical problems, the invention provides an underwater cutting device for shipwreck salvage with improved cutting efficiency.

The underwater cutting device for shipwreck salvage according to the invention comprises a lower support plate, an upper support plate, columnar support rods, and a reinforcing plate, and a plurality of columnar support rods and a reinforcing plate are provided between the lower support plate and the upper support plate, wherein it further comprises holding components, a moving component, and a rope saw component; two holding components are provided between the lower support plate and the upper support plate, and the two holding components are symmetrically arranged; a top of the upper support plate is provided with a moving component, and the moving component is provided with a rope saw component. When in use, place the pipe on the inner side of the right end of the lower support plate and the upper support plate, then operate the two holding components to hold the pipe, so that the two holding components cooperate with the lower support plate and the upper support plate to hold and fix the pipe, then start the rope saw component, then operate the moving component to drive the rope saw component to move to the right, so that the started rope saw component cuts the pipe. During the cutting process, the staff only needs to hold the device and the pipe to cut, and there is no need to adjust the defense of the cutting device, which improves the convenience of operation of the cutting personnel while improving the cutting efficiency.

Preferably, the holding component comprises a holding rod, a first pin shaft, a first hinge seat, an electric hydraulic cylinder, a second hinge seat, and a first mounting plate; the first pin shaft is rotatably provided between the lower support plate and the upper support plate; the first pin shaft is provided with a holding rod, and the holding rod is L-shaped; one end of the lower support plate and the upper support plate is provided with a first mounting plate; one end of the electric hydraulic cylinder is hinged to the first mounting plate via the second hinge seat, and the other end of the electric hydraulic cylinder is hinged to one end of the holding rod via the first hinge seat. When in use, the pipeline is on the inner side of the right end of the lower support plate and the upper support plate, and the two electric hydraulic cylinders are operated to extend, so that the two electric hydraulic cylinders respectively make the right ends of the two holding rods move closer in a mirror image with the cooperation of the corresponding first hinge seat and second hinge seat, and further make the two holding rods and the inner right ends of the lower support plate and the upper support plate hold the pipeline, thereby improving the cutting stability.

Preferably, the moving component comprises a guide rail, a guide moving seat, a second mounting plate, an underwater servo motor, a transmission screw, a U-shaped moving seat, a threaded connection block, a first sprocket, a second sprocket, a chain, and a strip-shaped opening; the top of the upper support plate is provided with two guide rails; a bottom of the U-shaped moving seat is provided with two guide moving seat, and each guide moving seat is slidably connected to a guide rail respectively; left ends of the lower support plate and the upper support plate are both connected to a right end of the second mounting plate, and the right end of the second mounting plate is provided with an underwater servo motor; the underwater servo motor is provided between the lower support plate and the upper support plate; an output end of the underwater servo motor extends to a left side of the second mounting plate and is provided with a second sprocket; a transmission screw is rotatably mounted between the reinforcing plate and the second mounting plate, and a left end of the transmission screw extends to the left side of the second mounting plate and is provided with a first sprocket; the first sprocket and the second sprocket are driven by the chain; the top of the upper support plate is provided with a strip-shaped opening, and a threaded connection block is passed through the strip-shaped opening; the threaded connection block is threaded to the transmission screw, and a top of the threaded connection block is connected to the bottom of the U-shaped moving seat; a top of the U-shaped moving seat is provided with a rope saw component. After the lower support plate, the upper support plate and the holding component cooperate to hold the pipeline, start the rope saw component, and then start the underwater servo motor, so that the second sprocket drives the first sprocket to rotate with the cooperation of the chain, and further drives the first sprocket to rotate between the lower support plate and the upper support plate. Since the transmission screw is threaded to the threaded connection block, the threaded connection block drives the U-shaped moving seat to move to the right with the cooperation of the guide slide rail and the guide moving seat, so that the U-shaped moving seat drives the rope saw component to move to the right, and further enables the rope saw component to cut the pipeline, thereby improving the cutting efficiency.

Preferably, the rope saw component comprises an L-shaped support frame, an underwater driving motor, a driving wheel, a first guide wheel, a second guide wheel, a third guide wheel, a rope saw, and a guide wheel adjusting component; the top of the U-shaped moving seat is fixedly provided with an L-shaped support frame, a top of the L-shaped support frame is provided with an underwater driving motor, and an output end of the underwater driving motor is provided with a driving wheel; the top of the U-shaped moving seat is rotatably provided with a first guide wheel, a second guide wheel, and a third guide wheel; the driving wheel, the first guide wheel, the second guide wheel, and the third guide wheel are arranged in a rectangular shape; the rope saw is sleeved on the outer sides of the driving wheel, the first guide wheel, the second guide wheel, and the third guide wheel; the top of the U-shaped moving seat is provided with a guide wheel adjusting component, and the guide wheel adjusting component is used to adjust the tightness of the rope saw. The rope saw is mounted on the outside of the driving wheel, the first guide wheel, the second guide wheel, and the third guide wheel, and the underwater driving motor is started, so that the underwater driving motor drives the driving wheel to rotate rapidly, and further the rope saw is rotated rapidly with the cooperation of the driving wheel, the first guide wheel, the second guide wheel, and the third guide wheel. When the rope saw contacts the shipwreck pipe, the rapidly rotating rope saw cuts the pipe. When the rope saw needs to be replaced after being used for a period of time, the staff can replace the rope saw that needs to be replaced by adjusting the tightness of the guide wheel adjusting component in contact with the rope saw, thereby improving convenience.

Preferably, it further comprises a fixing seat and a fixing plate; a bottom of the lower support plate is provided with two fixing seats, and the top of the upper support plate is provided with two fixing seats; one fixing seat on the lower support plate and one fixing seat on the upper support plate are mounted with a fixing plate. When cutting, use the fixing plates to hold the pipe tightly to improve firmness.

Preferably, the guide wheel adjusting component comprises a threaded groove, a locking bolt, an annular flat washer, a third mounting plate, an adjusting guide wheel, and a circular hole; the top of the U-shaped moving seat is provided with a threaded groove; a top of the third mounting plate is rotatably provided with an adjusting guide wheel, and the third mounting plate is provided with a circular hole; the locking bolt is passed through the circular hole, and the locking bolt is sleeved with an annular flat washer; the locking bolt is threaded to the threaded groove, and the adjusting guide wheel is on the outside of the rope saw. The locking bolt passes through the circular hole and is threaded to the threaded groove, thereby fixing the third mounting plate and the adjusting guide wheel. The adjusting guide wheel assists the rope saw to bypass the driving wheel, so that the driving wheel drives the rope saw. When the rope saw has been used for a period of time and needs to be replaced, the locking bolt is released from the threaded connection with the threaded groove, so that the third mounting plate and the adjusting guide wheel are moved, and the rope saw is replaced, thereby improving convenience.

Preferably, it further comprises fixed light bars and a protective side plate; a left of the second mounting plate is provided with a plurality of fixed light bars, and left ends of the plurality of fixed light bars are connected to a right end of the protective side plate; the first sprocket, the second sprocket, and the chain are all arranged between the protective side plate and the second mounting plate. When the underwater servo motor drives the second sprocket, the first sprocket, and the chain to rotate, the protective side plate and the plurality of fixed light bars cooperate with each other to form a protective space, reducing the occurrence of the first sprocket, the second sprocket, and the chain being entangled with foreign objects.

Preferably, it further comprises a second anti-slip pad, and right ends of the two fixing plates are respectively provided with a second anti-slip pad. The two fixing plates respectively hold the pipe tightly with the cooperation of the corresponding second anti-slip pads to improve the holding firmness.

Preferably, it further comprises a fluorescent coating, and a left of the protective side plate is provided with the fluorescent coating. When there is insufficient light underwater, the fluorescent coating indicates the location of the device, making it easier for cutting personnel to retrieve the device.

Preferably, it further comprises a first anti-slip pad, and inner ends of the two holding rods are respectively provided with a first anti-slip pad. The two holding rods respectively hold the pipe with the cooperation of the corresponding first anti-slip pads to improve the holding firmness.

Compared with the prior art, the invention has the following beneficial effects: when in use, place the pipe on the inner side of the right end of the lower support plate and the upper support plate, then operate the two holding components to hold the pipe, so that the two holding components cooperate with the lower support plate and the upper support plate to hold and fix the pipe, then start the rope saw component, then operate the moving component to drive the rope saw component to move to the right, so that the started rope saw component cuts the pipe. During the cutting process, the staff only needs to hold the device and the pipe to cut, and there is no need to adjust the defense of the cutting device, which improves the convenience of operation of the cutting personnel while improving the cutting efficiency.

### BRIEF DESCRIPTION OF THE DRAWINGS

FIG. 1 is a first axonometric diagram according to the invention;

FIG. 2 is a schematic diagram of a partial enlarged structure of part A in FIG. 1;

FIG. 3 is a second axonometric diagram according to the invention;

FIG. 4 is a third axonometric diagram according to the invention;

FIG. 5 is an exploded schematic diagram according to the invention;

FIG. 6 is an enlarged structural diagram of the lower support plate and the electric hydraulic cylinder according to the invention;

FIG. 7 is a first enlarged structural schematic diagram of the transmission screw and the threaded connection block according to the invention;

FIG. 8 is a second enlarged structural schematic diagram of the transmission screw and the threaded connection block according to the invention;

FIG. 9 is an enlarged structural schematic diagram of the protective side plate and the transmission screw according to the invention;

FIG. 10 is an enlarged structural schematic diagram of the first sprocket and the second sprocket according to the invention;

FIG. 11 is an enlarged structural schematic diagram of the rope saw and the U-shaped movable seat according to the invention;

FIG. 12 is an enlarged structural schematic diagram of the adjusting guide wheel and the locking bolt according to the invention.

In the figures: 101 refers to the lower support plate; 102 refers to the upper support plate; 103 refers to the columnar support rod; 104 refers to the reinforcing plate; 201 refers to the holding rod; 202 refers to the first pin shaft; 203 refers to the first hinge seat; 204 refers to the electric hydraulic cylinder; 206 refers to the second hinge seat; 207 refers to the first mounting plate; 208 refers to the first anti-slip pad; 301 refers to the guide rail; 302 refers to the guide moving seat; 303 refers to the second mounting plate; 304 refers to the underwater servo motor; 305 refers to the transmission screw; 306 refers to the U-shaped moving seat; 307 refers to the threaded connection block; 308 refers to the first sprocket; 309 refers to the second sprocket; 310 refers to the chain; 311 refers to the strip-shaped opening; 312 refers to the fixed light bar; 313 refers to the protective side plate; 314 refers to the fluorescent coating; 401 refers to the L-shaped support frame; 402 refers to the underwater driving motor; 403 refers to the driving wheel; 404 refers to the first guide wheel; 405 refers to the second guide wheel; 406 refers to the third guide wheel; 407 refers to the rope saw; 501 refers to the fixing seat; 502 refers to the fixing plate; 503 refers to the second anti-slip pad; 601 refers to the threaded groove; 602 refers to the locking bolt; 603 refers to the annular flat washer; 604 refers to the third mounting plate; 605 refers to the adjusting guide wheel; 606 refers to the circular hole.

### SPECIFIC EMBODIMENT OF THE INVENTION

In order to facilitate understanding of the invention, the invention will be described more fully hereinafter with reference to the drawings. The invention can be implemented in many different forms and is not limited to the embodiments described herein. On the contrary, the purpose of providing these embodiments is to make the disclosure of the invention more thorough and comprehensive.

### Embodiment 1

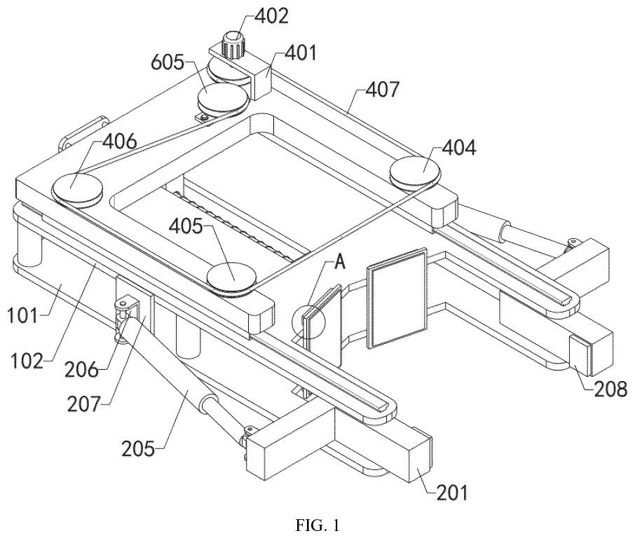

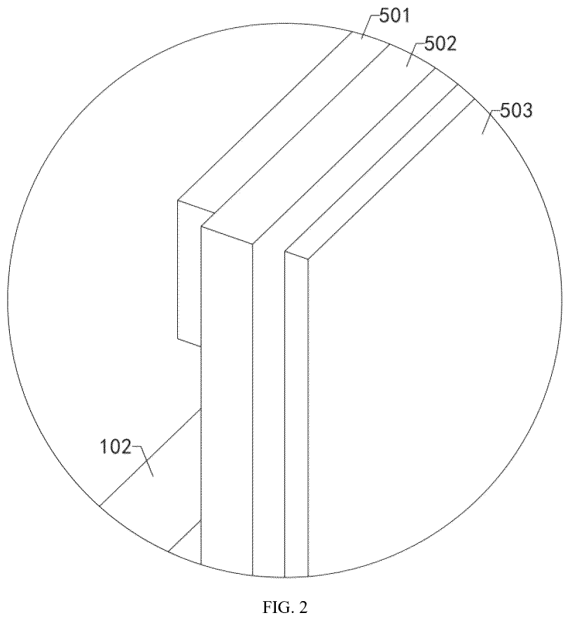

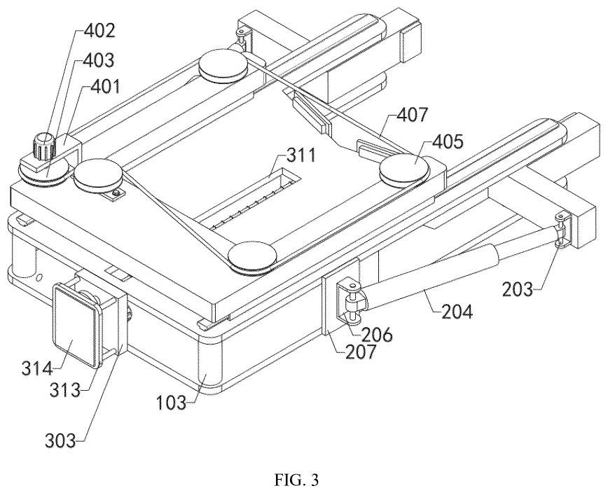

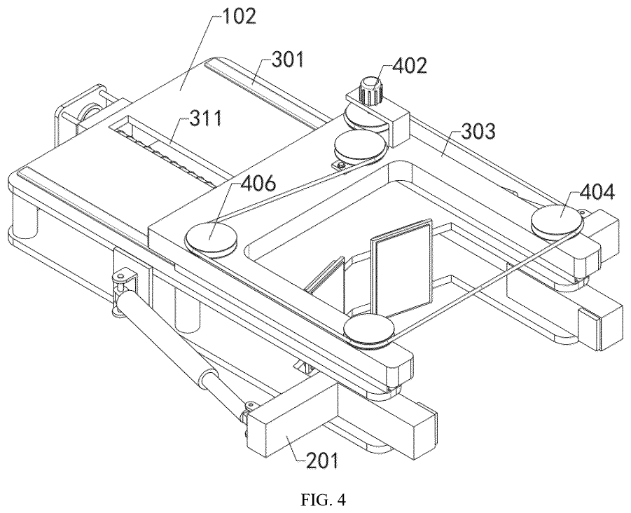

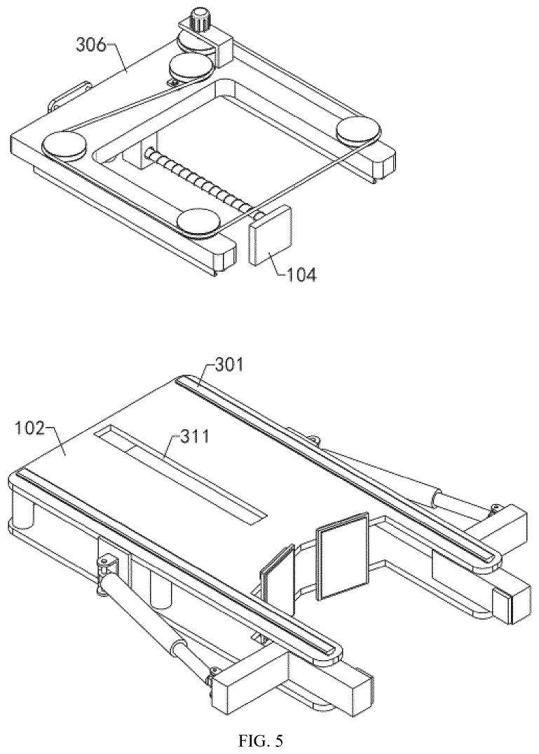

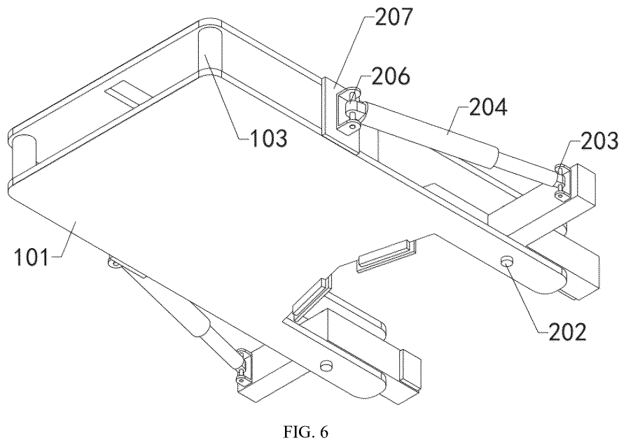

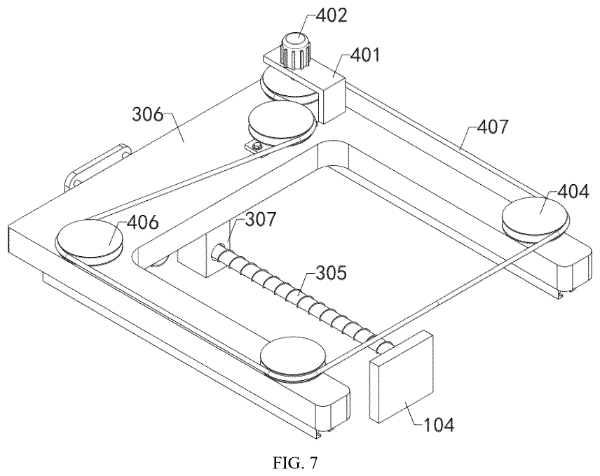

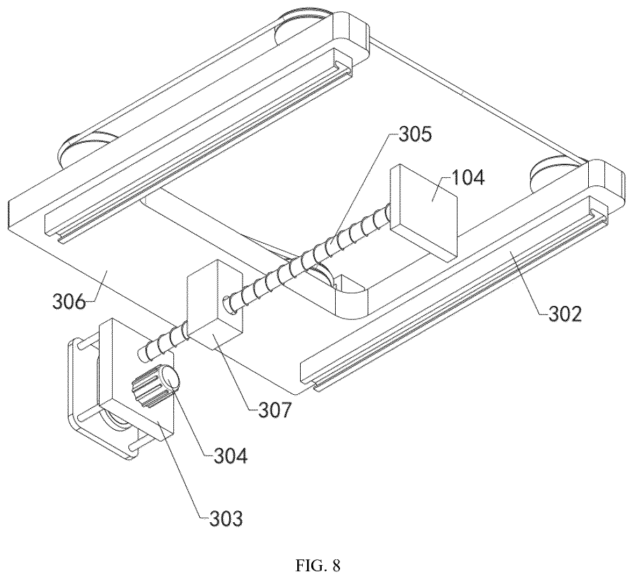

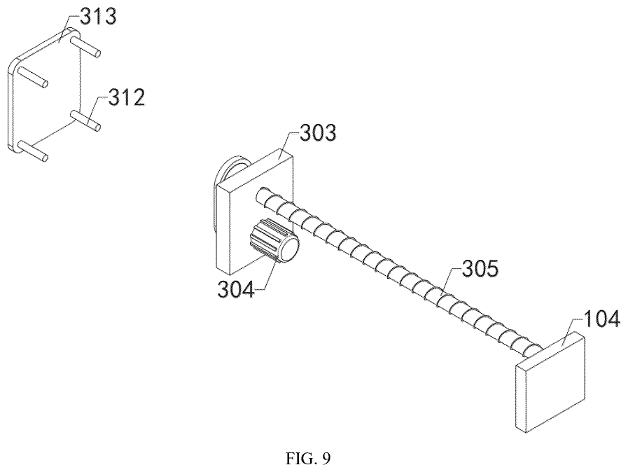

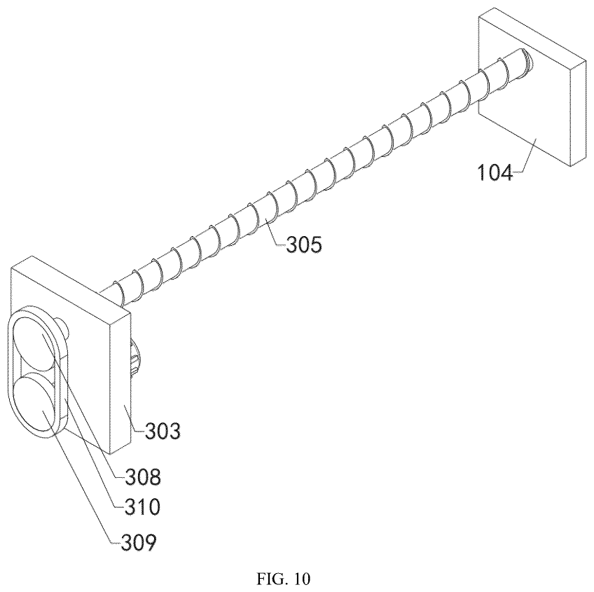

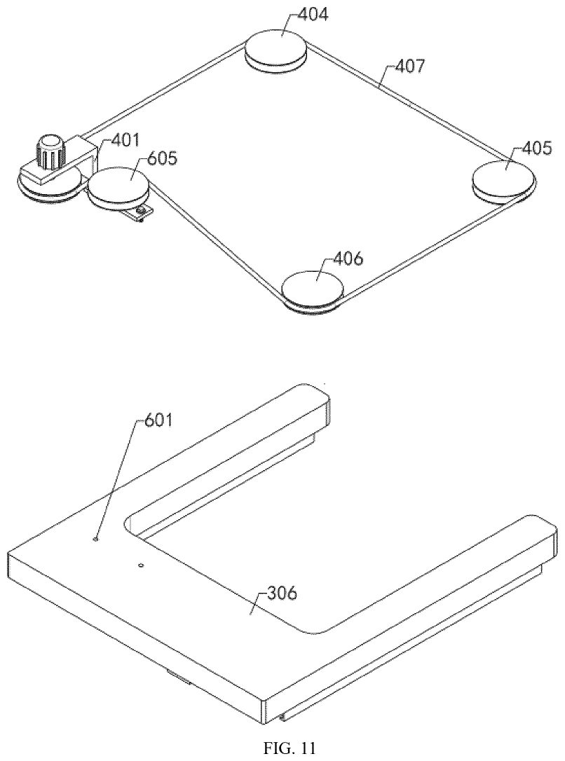

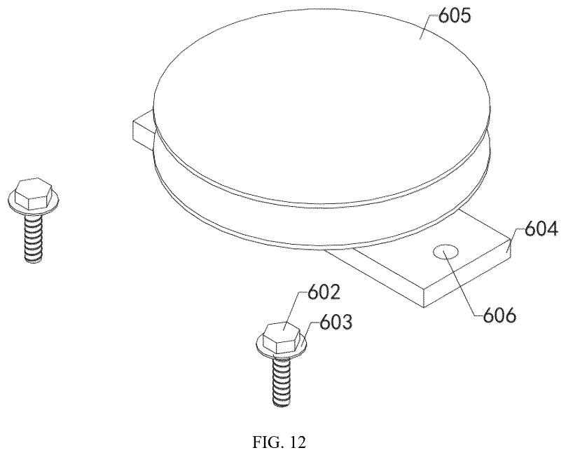

As shown in FIGS. 1-12, the invention provides a underwater cutting device for shipwreck salvage, comprising a lower support plate 101, an upper support plate 102, columnar support rods 103, and a reinforcing plate 104, and a plurality of columnar support rods 103 and a reinforcing plate 104 are provided between the lower support plate 101 and the upper support plate 102, wherein it further comprises holding components, a moving component, and a rope saw component; two holding components are provided between the lower support plate 101 and the upper support plate 102, and the two holding components are symmetrically arranged; a top of the upper support plate 102 is provided with a moving component, and the moving component is provided with a rope saw component;
the holding component comprises a holding rod 201, a first pin shaft 202, a first hinge seat 203, an electric hydraulic cylinder 204, a second hinge seat 206, and a first mounting plate 207; the first pin shaft 202 is rotatably provided between the lower support plate 101 and the upper support plate 102; the first pin shaft 202 is provided with a holding rod 201, and the holding rod 201 is L-shaped; one end of the lower support plate 101 and the upper support plate 102 is provided with a first mounting plate 207; one end of the electric hydraulic cylinder 204 is hinged to the first mounting plate 207 via the second hinge seat 206, and the other end of the electric hydraulic cylinder 204 is hinged to one end of the holding rod 201 via the first hinge seat 203;
the moving component comprises a guide rail 301, a guide moving seat 302, a second mounting plate 303, an underwater servo motor 304, a transmission screw 305, a U-shaped moving seat 306, a threaded connection block 307, a first sprocket 308, a second sprocket 309, a chain 310, and a strip-shaped opening 311; the top of the upper support plate 102 is provided with two guide rails 301; a bottom of the U-shaped moving seat 306 is provided with two guide moving seat 302, and each guide moving seat 302 is slidably connected to a guide rail 301 respectively; left ends of the lower support plate 101 and the upper support plate 102 are both connected to a right end of the second mounting plate 303, and the right end of the second mounting plate 303 is provided with an underwater servo motor 304; the underwater servo motor 304 is provided between the lower support plate 101 and the upper support plate 102; an output end of the underwater servo motor 304 extends to a left side of the second mounting plate 303 and is provided with a second sprocket 309; a transmission screw 305 is rotatably mounted between the reinforcing plate 104 and the second mounting plate 303, and a left end of the transmission screw 305 extends to the left side of the second mounting plate 303 and is provided with a first sprocket 308; the first sprocket 308 and the second sprocket 309 are driven by the chain 310; the top of the upper support plate 102 is provided with a strip-shaped opening 311, and a threaded connection block 307 is passed through the strip-shaped opening 311; the threaded connection block 307 is threaded to the transmission screw 305, and a top of the threaded connection block 307 is connected to the bottom of the U-shaped moving seat 306; a top of the U-shaped moving seat 306 is provided with a rope saw component;
the rope saw component comprises an L-shaped support frame 401, an underwater driving motor 402, a driving wheel 403, a first guide wheel 404, a second guide wheel 405, a third guide wheel 406, a rope saw 407, and a guide wheel adjusting component; the top of the U-shaped moving seat 306 is fixedly provided with an L-shaped support frame 401, a top of the L-shaped support frame 401 is provided with an underwater driving motor 402, and an output end of the underwater driving motor 402 is provided with a driving wheel 403; the top of the U-shaped moving seat 306 is rotatably provided with a first guide wheel 404, a second guide wheel 405, and a third guide wheel 406; the driving wheel 403, the first guide wheel 404, the second guide wheel 405, and the third guide wheel 406 are arranged in a rectangular shape; the rope saw 407 is sleeved on the outer sides of the driving wheel 403, the first guide wheel 404, the second guide wheel 405, and the third guide wheel 406; the top of the U-shaped moving seat 406 is provided with a guide wheel adjusting component, and the guide wheel adjusting component is used to adjust the tightness of the rope saw 407;
it further comprises a fixing seat 501 and a fixing plate 502; a bottom of the lower support plate 101 is provided with two fixing seats 501, and the top of the upper support plate 102 is provided with two fixing seats 501; one fixing seat 501 on the lower support plate 101 and one fixing seat 501 on the upper support plate 102 are mounted with a fixing plate 502.

In the embodiment, when in use, the pipeline is on the inner side of the right end of the lower support plate 101 and the upper support plate 102, and the two electric hydraulic cylinders 204 are operated to extend, so that the two electric hydraulic cylinders 204 respectively make the right ends of the two holding rods 201 move closer in a mirror image with the cooperation of the corresponding first hinge seat 203 and second hinge seat 206, and further make the two holding rods 201 and the inner right ends of the lower support plate 101 and the upper support plate 102 hold the pipeline; the underwater driving motor 402 is started, so that the underwater driving motor 402 drives the driving wheel 403 to rotate rapidly, and further the rope saw 407 is rotated rapidly with the cooperation of the driving wheel 430, the first guide wheel 404, the second guide wheel 405, and the third guide wheel 406; then start the underwater servo motor 304, so that the second sprocket 309 drives the first sprocket 308 to rotate with the cooperation of the chain 310, and further drives the first sprocket 308 to rotate between the lower support plate 101 and the upper support plate 102. Since the transmission screw 305 is threaded to the threaded connection block 307, the threaded connection block 307 drives the U-shaped moving seat 306 to move to the right with the cooperation of the guide slide rail 301 and the guide moving seat 302, so that the U-shaped moving seat 306 drives the rope saw component to move to the right.

When the rope saw 407 contacts the shipwreck pipe, the rapidly rotating rope saw 407 cuts the pipe. When the rope saw 407 needs to be replaced after being used for a period of time, the staff can replace the rope saw 407 that needs to be replaced by adjusting the tightness of the guide wheel adjusting component in contact with the rope saw 407.

### Embodiment 2

As shown in FIGS. 1-12, the invention provides a underwater cutting device for shipwreck salvage, comprising a lower support plate 101, an upper support plate 102, columnar support rods 103, and a reinforcing plate 104, and a plurality of columnar support rods 103 and a reinforcing plate 104 are provided between the lower support plate 101 and the upper support plate 102, wherein it further comprises holding components, a moving component, and a rope saw component; two holding components are provided between the lower support plate 101 and the upper support plate 102, and the two holding components are symmetrically arranged; a top of the upper support plate 102 is provided with a moving component, and the moving component is provided with a rope saw component;
the holding component comprises a holding rod 201, a first pin shaft 202, a first hinge seat 203, an electric hydraulic cylinder 204, a second hinge seat 206, and a first mounting plate 207;
the first pin shaft 202 is rotatably provided between the lower support plate 101 and the upper support plate 102; the first pin shaft 202 is provided with a holding rod 201, and the holding rod 201 is L-shaped; one end of the lower support plate 101 and the upper support plate 102 is provided with a first mounting plate 207; one end of the electric hydraulic cylinder 204 is hinged to the first mounting plate 207 via the second hinge seat 206, and the other end of the electric hydraulic cylinder 204 is hinged to one end of the holding rod 201 via the first hinge seat 203;
the moving component comprises a guide rail 301, a guide moving seat 302, a second mounting plate 303, an underwater servo motor 304, a transmission screw 305, a U-shaped moving seat 306, a threaded connection block 307, a first sprocket 308, a second sprocket 309, a chain 310, and a strip-shaped opening 311; the top of the upper support plate 102 is provided with two guide rails 301; a bottom of the U-shaped moving seat 306 is provided with two guide moving seat 302, and each guide moving seat 302 is slidably connected to a guide rail 301 respectively; left ends of the lower support plate 101 and the upper support plate 102 are both connected to a right end of the second mounting plate 303, and the right end of the second mounting plate 303 is provided with an underwater servo motor 304; the underwater servo motor 304 is provided between the lower support plate 101 and the upper support plate 102; an output end of the underwater servo motor 304 extends to a left side of the second mounting plate 303 and is provided with a second sprocket 309; a transmission screw 305 is rotatably mounted between the reinforcing plate 104 and the second mounting plate 303, and a left end of the transmission screw 305 extends to the left side of the second mounting plate 303 and is provided with a first sprocket 308; the first sprocket 308 and the second sprocket 309 are driven by the chain 310; the top of the upper support plate 102 is provided with a strip-shaped opening 311, and a threaded connection block 307 is passed through the strip-shaped opening 311; the threaded connection block 307 is threaded to the transmission screw 305, and a top of the threaded connection block 307 is connected to the bottom of the U-shaped moving seat 306; a top of the U-shaped moving seat 306 is provided with a rope saw component;
the rope saw component comprises an L-shaped support frame 401, an underwater driving motor 402, a driving wheel 403, a first guide wheel 404, a second guide wheel 405, a third guide wheel 406, a rope saw 407, and a guide wheel adjusting component; the top of the U-shaped moving seat 306 is fixedly provided with an L-shaped support frame 401, a top of the L-shaped support frame 401 is provided with an underwater driving motor 402, and an output end of the underwater driving motor 402 is provided with a driving wheel 403; the top of the U-shaped moving seat 306 is rotatably provided with a first guide wheel 404, a second guide wheel 405, and a third guide wheel 406; the driving wheel 403, the first guide wheel 404, the second guide wheel 405, and the third guide wheel 406 are arranged in a rectangular shape; the rope saw 407 is sleeved on the outer sides of the driving wheel 403, the first guide wheel 404, the second guide wheel 405, and the third guide wheel 406; the top of the U-shaped moving seat 406 is provided with a guide wheel adjusting component, and the guide wheel adjusting component is used to adjust the tightness of the rope saw 407;
it further comprises a fixing seat 501 and a fixing plate 502; a bottom of the lower support plate 101 is provided with two fixing seats 501, and the top of the upper support plate 102 is provided with two fixing seats 501; one fixing seat 501 on the lower support plate 101 and one fixing seat 501 on the upper support plate 102 are mounted with a fixing plate 502;
the guide wheel adjusting component comprises a threaded groove 601, a locking bolt 602, an annular flat washer 603, a third mounting plate 604, an adjusting guide wheel 605, and a circular hole 606; the top of the U-shaped moving seat 306 is provided with a threaded groove 601; a top of the third mounting plate 604 is rotatably provided with an adjusting guide wheel 605, and the third mounting plate 604 is provided with a circular hole 606; the locking bolt 602 is passed through the circular hole 606, and the locking bolt 602 is sleeved with an annular flat washer 603; the locking bolt 602 is threaded to the threaded groove 601, and the adjusting guide wheel 605 is on the outside of the rope saw 407;
it further comprises fixed light bars 312 and a protective side plate 313; a left of the second mounting plate 303 is provided with a plurality of fixed light bars 312, and left ends of the plurality of fixed light bars 312 are connected to a right end of the protective side plate 313; the first sprocket 308, the second sprocket 309, and the chain 310 are all arranged between the protective side plate 313 and the second mounting plate 303;
it further comprises a second anti-slip pad 503, and right ends of the two fixing plates 502 are respectively provided with a second anti-slip pad 503;
it further comprises a fluorescent coating 314, and a left of the protective side plate 313 is provided with the fluorescent coating 314;
it further comprises a first anti-slip pad 208, and inner ends of the two holding rods 201 are respectively provided with a first anti-slip pad 208.

In the embodiment, when in use, the pipeline is on the inner side of the right end of the lower support plate 101 and the upper support plate 102, and the two electric hydraulic cylinders 204 are operated to extend, so that the two electric hydraulic cylinders 204 respectively make the right ends of the two holding rods 201 move closer in a mirror image with the cooperation of the corresponding first hinge seat 203 and second hinge seat 206, and further make the two holding rods 201 and the inner right ends of the lower support plate 101 and the upper support plate 102 hold the pipeline; the underwater driving motor 402 is started, so that the underwater driving motor 402 drives the driving wheel 403 to rotate rapidly, and further the rope saw 407 is rotated rapidly with the cooperation of the driving wheel 430, the first guide wheel 404, the second guide wheel 405, and the third guide wheel 406; then start the underwater servo motor 304, so that the second sprocket 309 drives the first sprocket 308 to rotate with the cooperation of the chain 310, and further drives the first sprocket 308 to rotate between the lower support plate 101 and the upper support plate 102. Since the transmission screw 305 is threaded to the threaded connection block 307, the threaded connection block 307 drives the U-shaped moving seat 306 to move to the right with the cooperation of the guide slide rail 301 and the guide moving seat 302, so that the U-shaped moving seat 306 drives the rope saw component to move to the right. When the rope saw 407 contacts the shipwreck pipe, the rapidly rotating rope saw 407 cuts the pipe. The locking bolt 602 passes through the circular hole 606 and is threaded to the threaded groove 601, thereby fixing the third mounting plate 604 and the adjusting guide wheel 605. The adjusting guide wheel 605 assists the rope saw 407 to bypass the driving wheel 403, so that the driving wheel 403 drives the rope saw 407. When the rope saw 407 has been used for a period of time and needs to be replaced, the locking bolt 602 is released from the threaded connection with the threaded groove 601, so that the third mounting plate 604 and the adjusting guide wheel 605 are moved, and the rope saw 407 is replaced. When the underwater servo motor 304 drives the second sprocket 309, the first sprocket 308, and the chain 310 to rotate, the protective side plate 313 and the plurality of fixed light bars 312 cooperate with each other to form a protective space, reducing the occurrence of the first sprocket 308, the second sprocket 309, and the chain 310 being entangled with foreign objects.

The underwater cutting device for shipwreck salvage according to the invention has common mechanical installation, connection or setting methods, and can be implemented as long as it can achieve its beneficial effects. The rope saw is a saw that completes the cutting of brittle and hard materials by high-speed rotation cutting of the diamond saw rope, and its use method is flexible: both horizontal and vertical cutting are possible. The electric hydraulic cylinder 204, underwater servo motor 304, first sprocket 308, second sprocket 309, chain 310, underwater drive motor 402, driving wheel 403, first guide wheel 404, second guide wheel 405, third guide wheel 406, and rope saw 407 of the underwater cutting device for shipwreck salvage according to the invention are purchased on the market, and technicians in the industry only need to install and operate according to the accompanying instruction manual, without the need for creative labor by technicians in the field.

The above is only a preferred embodiment of the invention. It should be pointed out that for ordinary technicians in this technical field, several improvements and modifications can be made without departing from the technical principles of the invention. These improvements and modifications should also be regarded as the protection scope of the invention.

1. An underwater cutting device for shipwreck salvage, comprising a lower support plate, an upper support plate, columnar support rods, and reinforcing plates, and a plurality of columnar support rods and a group reinforcing plate are provided between the lower support plate and the upper support plate, wherein the cutting device further comprises holding components, a moving component, and a rope saw component; two holding components are provided between the lower support plate and the upper support plate, and the two holding components are symmetrically arranged; a top of the upper support plate is provided with a moving component, and the moving component is provided with a rope saw component.

2. The underwater cutting device for shipwreck salvage of claim 1, wherein the holding component comprises a holding rod, a first pin shaft, a first hinge seat, an electric hydraulic cylinder, a second hinge seat, and a first mounting plate; the first pin shaft is rotatably provided between the lower support plate and the upper support plate; the first pin shaft is provided with a holding rod, and the holding rod is L-shaped; one end of the lower support plate and the upper support plate is provided with a first mounting plate; one end of the electric hydraulic cylinder is hinged to the first mounting plate via the second hinge seat, and the other end of the electric hydraulic cylinder is hinged to one end of the holding rod via the first hinge seat.

3. The underwater cutting device for shipwreck salvage of claim 1, wherein the moving component comprises a guide rail, a guide moving seat, a second mounting plate, an underwater servo motor, a transmission screw, a U-shaped moving seat, a threaded connection block, a first sprocket, a second sprocket, a chain, and a strip-shaped opening; the top of the upper support plate is provided with two guide rails; a bottom of the U-shaped moving seat is provided with two guide moving seat, and each guide moving seat is slidably connected to a guide rail respectively; left ends of the lower support plate and the upper support plate are both connected to a right end of the second mounting plate, and the right end of the second mounting plate is provided with an underwater servo motor; the underwater servo motor is provided between the lower support plate and the upper support plate; an output end of the underwater servo motor extends to a left side of the second mounting plate and is provided with a second sprocket; a transmission screw is rotatably mounted between the reinforcing plate and the second mounting plate, and a left end of the transmission screw extends to the left side of the second mounting plate and is provided with a first sprocket; the first sprocket and the second sprocket are driven by the chain; the top of the upper support plate is provided with a strip-shaped opening, and a threaded connection block is passed through the strip-shaped opening; the threaded connection block is threaded to the transmission screw, and a top of the threaded connection block is connected to the bottom of the U-shaped moving seat; a top of the U-shaped moving seat is provided with a rope saw component.

4. The underwater cutting device for shipwreck salvage of claim 3, wherein the rope saw component comprises an L-shaped support frame, an underwater driving motor, a driving wheel, a first guide wheel, a second guide wheel, a third guide wheel, a rope saw, and a guide wheel adjusting component; the top of the U-shaped moving seat is fixedly provided with an L-shaped support frame, a top of the L-shaped support frame is provided with an underwater driving motor, and an output end of the underwater driving motor is provided with a driving wheel; the top of the U-shaped moving seat is rotatably provided with a first guide wheel, a second guide wheel, and a third guide wheel; the driving wheel, the first guide wheel, the second guide wheel, and the third guide wheel are arranged in a rectangular shape; the rope saw is sleeved on the outer sides of the driving wheel, the first guide wheel, the second guide wheel, and the third guide wheel; the top of the U-shaped moving seat is provided with a guide wheel adjusting component, and the guide wheel adjusting component is used to adjust the tightness of the rope saw.

5. The underwater cutting device for shipwreck salvage of claim 4, wherein it further comprises a fixing seat and a fixing plate; a bottom of the lower support plate is provided with two fixing seats, and the top of the upper support plate is provided with two fixing seats; one fixing seat on the lower support plate and one fixing seat on the upper support plate are mounted with a fixing plate.

6. The underwater cutting device for shipwreck salvage of claim 4, wherein the guide wheel adjusting component comprises a threaded groove, a locking bolt, an annular flat washer, a third mounting plate, an adjusting guide wheel, and a circular hole; the top of the U-shaped moving seat is provided with a threaded groove; a top of the third mounting plate is rotatably provided with an adjusting guide wheel, and the third mounting plate is provided with a circular hole; the locking bolt is passed through the circular hole, and the locking bolt is sleeved with an annular flat washer; the locking bolt is threaded to the threaded groove, and the adjusting guide wheel is on the outside of the rope saw.

7. The underwater cutting device for shipwreck salvage of claim 3, wherein it further comprises fixed light bars and a protective side plate; a left of the second mounting plate is provided with a plurality of fixed light bars, and left ends of the plurality of fixed light bars are connected to a right end of the protective side plate; the first sprocket, the second sprocket, and the chain are all arranged between the protective side plate and the second mounting plate.

8. The underwater cutting device for shipwreck salvage of claim 5, wherein it further comprises a second anti-slip pad, and right ends of the two fixing plates are respectively provided with a second anti-slip pad.

9. The underwater cutting device for shipwreck salvage of claim 3, wherein it further comprises a fluorescent coating, and a left of the protective side plate is provided with the fluorescent coating.

10. The underwater cutting device for shipwreck salvage of claim 2, wherein it further comprises a first anti-slip pad, and inner ends of the two holding rods are respectively provided with a first anti-slip pad.
